(19) United States
(12) Patent Application Publication
(10) Pub. No.: US 2014/0115386 A1
(43) Pub. Date: Apr. 24, 2014

(54) SERVER AND METHOD FOR MANAGING SERVER

(71) Applicant: HON HAI PRECISION INDUSTRY CO., LTD., New Taipei (TW)

(72) Inventor: YU-CHEN HUANG, New Taipei (TW)

(73) Assignee: HON HAI PRECISION INDUSTRY CO., LTD., New Taipei (TW)

(21) Appl. No.: 13/859,578

(22) Filed: Apr. 9, 2013

(30) Foreign Application Priority Data
Oct. 24, 2012 (TW) 101139215

(51) Int. Cl. G06F 11/07; G06F 11/14

(52) U.S. Cl. CPC G06F 11/0709; G06F 11/1412
USPC 714/15; 714/48

(57) ABSTRACT

In a method for managing a server, when the server malfunctions, a present abnormality of the server is determined according to data from a memory of the server. A reason of the present abnormality is determined according to a preset reason list, in response to determining that the present abnormality is a hardware abnormality. Use of the abnormal hardware is stopped and an operating system of the server is controlled to restart. Information of the abnormal hardware is acquired from a field replace unit (FRU) chip of the server. The present abnormality of the server, the reason of the present abnormality, and the information of the abnormal hardware is transmitted to the computing device.

### BACKGROUND

1. Technical Field

Embodiments of the present disclosure generally relate to server management, and particularly to a server and a method for managing the server.

2. Description of Related Art

One or more servers can be in a locked room. If a server in the room malfunctions, someone should enter the room, check all of the servers to find the malfunctioning server and repair or replace the malfunctioning server. Since there may be many servers in the room, checking all of the servers may be time-consuming.

### BRIEF DESCRIPTION OF THE DRAWINGS

FIG. 1 is a schematic diagram of one embodiment of a server and a computing device.

FIG. 2 is a block diagram of one embodiment of function modules of a management unit of the server in FIG. 1.

FIG. 3 is a flowchart of one embodiment of a method for managing the server in FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

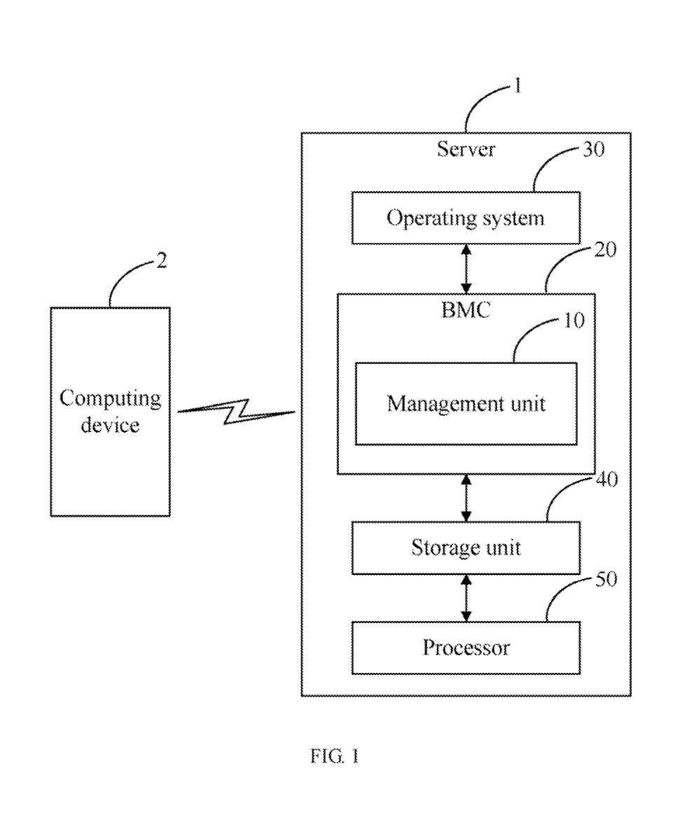

FIG. 1 is a schematic diagram of one embodiment of a server 1 and a computing device 2. In the embodiment, one or more servers 1 (only one is shown in FIG. 1) are in a room, and each of the one or more servers 1 include an operating system 30, a storage unit 40, a processor 50, and a baseboard management controller (BMC) 20 which includes a management unit 10. The one or more servers 1 are electronically connected to a computing device 2 outside of the room. The computing device 2 remotely monitors the one or more servers 1, receives information from a malfunctioning server 1, and displays the information to managers. The malfunctioning server 1 may have one or more hardware or software problems associated with the server 1, such as an over-heated processor, for example.

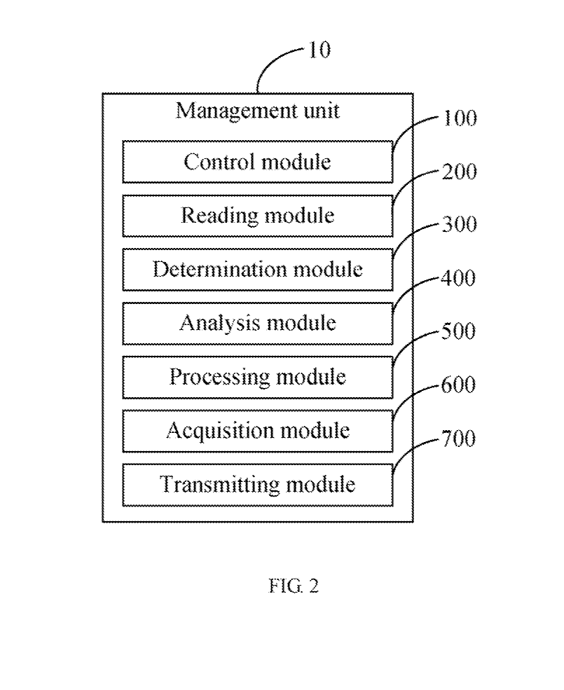

In one embodiment, the management unit 10 may include one or more function modules (as shown in FIG. 2). The one or more function modules may comprise computerized code in the form of one or more programs that are stored in the storage unit 40, and executed by the processor 50 to provide the functions of the management unit 10. The storage unit 40 is a dedicated memory, such as an EPROM or a flash memory.

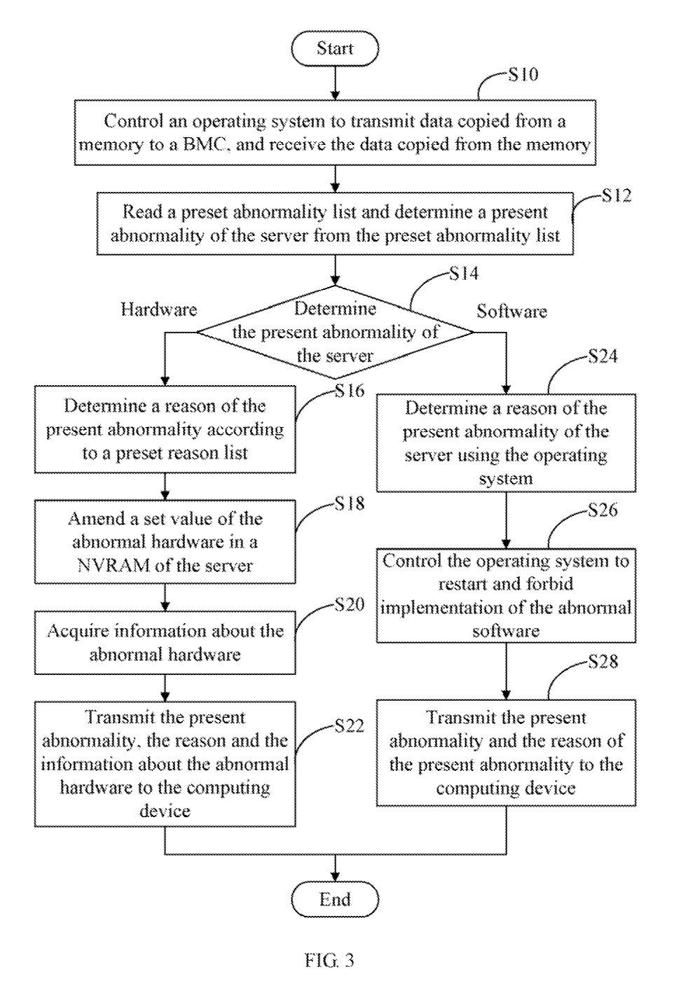

FIG. 2 is a block diagram of one embodiment of the function modules of the management unit 10. In one embodiment, the management unit 10 includes a control module 100, a reading module 200, a determination module 300, an analysis module 400, a processing module 500, an acquisition module 600, and a transmitting module 700. A description of the functions of the modules 100-700 is given with reference to FIG. 3.

FIG. 3 is a flowchart of one embodiment of a method for managing the server 1. Depending on the embodiment, additional steps may be added, others removed, and the ordering of the steps may be changed, all steps are labeled with even numbers only.

In step S10, when the server 1 malfunctions, the control module 100 controls the operating system 30 to transmit data copied from a memory of the server 1 to the BMC 20, and the control module 100 receives the data copied from the memory. In detail, when the server 1 malfunctions, the operating system 30 automatically copies the data in the memory, then the control module 100 controls the operating system 30 to transmit the data to the BMC 20 by an interface of the server 1 for communicating with the BMC 20.

In step S12, the reading module 200 reads a preset abnormality list and determines a present abnormality of the server 1 from the preset abnormality list, according to the data copied from the memory. In the embodiment, the preset abnormality list records common abnormalities of the server 1, and is stored in the storage unit 40. The common abnormalities may include: a CPU of the server 1 has a high temperature, a channel A of the memory cannot be accessed, or the CPU is under a 100% load, for example.

In step S14, the determination module 300 determines whether the present abnormality of the server 1 is a hardware abnormality or a software abnormality. For example, if the CPU has a high temperature or the channel A of the memory cannot be accessed, the present abnormality is a hardware abnormality. If the CPU is under the 100% load, the present abnormality is a software abnormality. If the present abnormality is a hardware abnormality, steps S16-S22 are implemented. If the present abnormality is a software abnormality, steps S24-S28 are implemented.

In step S16, the analysis module 400 determines a reason of the present abnormality of the server 1 according to a preset reason list. The preset reason list records reasons corresponding to the hardware abnormalities. For example, if the CPU has a high temperature, the reason may be that a fan of the CPU is non-operational; if the memory cannot be accessed, the reason may be that the memory malfunctions.

In step S18, the processing module 500 amends a set value of the abnormal hardware in a non-volatile random access memory (NVRAM) of a basic input output system (BIOS) of the server 1 according to the reason of the present abnormality. The set amended set value causes immediate disuse of the abnormal hardware and restarts the operating system 30. For example, if the fan of the CPU is non-operational, the processing module 500 may amend the set value of the fan in the NVRAM, to stop using the fan, and restart the operating system 30 Then, the operating system 30 may work normally.

In step S20, the acquisition module 600 acquires information of the abnormal hardware from a field replace unit (FRU) chip in a motherboard (not shown in FIG. 1) of the server 1. The FRU chip records information of all hardware devices of the server 1, including a model number of the CPU, a storage capacity and a model number of the memory, for example.

In step S22, the transmitting module 700 transmits the present abnormality of the server 1, the reason of the present abnormality, and the information of the abnormal hardware to the computing device 2. In the embodiment, the transmitting module 700 transmits an e-mail to the computing device 2 to notify the present abnormality of the server 1, the reason of the present abnormality, and the information of the abnormal hardware to the managers. So a person may prepare a standby hardware to replace the abnormal hardware before entering the room, and find the malfunctioning server 1 quickly.

In step S24, the analysis module 400 determines a reason of the present abnormality of the server 1 using the operating system 30. In the embodiment, the analysis module 400 may determine the reason of the present abnormality in a manner similar to anti-virus programs. For example, if the CPU is under the 100% load, the operating system 30 has a “taskmgr” program for determining a storage space used by each software process.

In step S26, the processing module 500 controls the operating system 30 to restart and forbids implementation of the abnormal software by a preset program. The preset program can end a process of the abnormal software, similar to a task manager of WINDOWS.

In step S28, the transmitting module 700 transmits the present abnormality of the server 1 and the reason of the present abnormality to the computing device 2. In the embodiment, the transmitting module 700 transmits an e-mail to the computing device 2 to notify the present abnormality of the server 1 and the reason of the present abnormality to the people to fix the problem.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method being executed by a processor of a server electronically connected to a computing device, the method comprising:
(a) determining a present abnormality of the server according to data from a memory of the server, in response to determining that the server is malfunctioning;
(b) determining a reason of the present abnormality of the server according to a preset reason list, in response to determining that the present abnormality is a hardware abnormality;
(c) stopping use of the abnormal hardware and controlling an operating system of the server to restart;
(d) acquiring information of the abnormal hardware from a field replace unit (FRU) chip of the server; and
(e) transmitting the present abnormality of the server, the reason of the present abnormality, and the information of the abnormal hardware to the computing device.

2. The method as claimed in claim 1, further comprising:
determining the reason of the present abnormality of the server using the operating system, in response to determining that the present abnormality is a software abnormality;
controlling the operating system to restart and forbidding implementation of the abnormal software by a preset program; and
transmitting the present abnormality of the server and the reason of the present abnormality to the computing device.

3. The method as claimed in claim 1, wherein in step (c), stopping use of the abnormal hardware is done by amending a set value of the abnormal hardware in a non-volatile random access memory (NVRAM) of a basic input output system (BIOS) of the server according to the reason of the present abnormality.

4. The method as claimed in claim 1, wherein the operating system automatically copies the data in the memory and transmits the data to a baseboard management controller (BMC) of the server in response to the determination that the server is malfunctioning.

5. A non-transitory storage medium storing a set of instructions, the set of instructions being executed by a processor of a server electronically connected to a computing device, to perform a method comprising:
(a) determining a present abnormality of the server according to data from a memory of the server, in response to determining that the server is malfunctioning;
(b) determining a reason of the present abnormality of the server according to a preset reason list, in response to determining that the present abnormality is a hardware abnormality;
(c) stopping use of the abnormal hardware and controlling an operating system of the server to restart;
(d) acquiring information of the abnormal hardware from a field replace unit (FRU) chip of the server; and
(e) transmitting the present abnormality of the server, the reason of the present abnormality, and the information of the abnormal hardware to the computing device.

6. The non-transitory storage medium as claimed in claim 5, wherein the method further comprises:
determining the reason of the present abnormality of the server using the operating system, in response to determining that the present abnormality is a software abnormality;
controlling the operating system to restart and forbidding implementation of the abnormal software by a preset program; and
transmitting the present abnormality of the server and the reason of the present abnormality to the computing device.

7. The non-transitory storage medium as claimed in claim 5, wherein in step (c), stopping use of the abnormal hardware is done by amending a set value of the abnormal hardware in a non-volatile random access memory (NVRAM) of a basic input output system (BIOS) of the server according to the reason of the present abnormality.

8. The non-transitory storage medium as claimed in claim 5, wherein the operating system automatically copies the data in the memory and transmits the data to a baseboard management controller (BMC) of the server in response to the determination that the server is malfunctioning.

9. A server electronically connected to a computing device, the server comprising:
an operating system;
a storage unit;
at least one processor;
one or more programs that are stored in the storage unit and are executed by the at least one processor, the one or more programs comprising:
a reading module that determines a present abnormality of the server according to data from a memory of the server, in response to determining that the server is malfunctioning;
an analysis module that determines a reason of the present abnormality of the server according to a preset reason list, in response to determining that the present abnormality is a hardware abnormality;
a processing module that stops use of the abnormal hardware and controls the operating system to restart;
an acquisition module that acquires information of the abnormal hardware from a field replace unit (FRU) chip of the server; and
a transmitting module that transmits the present abnormality of the server, the reason of the present abnormality, and the information of the abnormal hardware to the computing device.

10. The server as claimed in claim 9, wherein:
the analysis module further determines the reason of the present abnormality of the server using the operating system, in response to determining that the present abnormality is a software abnormality;
the processing module further controls the operating system to restart and forbids implementation of the abnormal software by a preset program; and
the transmitting module further transmits the present abnormality of the server and the reason of the present abnormality to the computing device.

11. The server as claimed in claim 9, wherein the processing module stops use of the abnormal hardware by amending a set value of the abnormal hardware in a non-volatile random access memory (NVRAM) of a basic input output system (BIOS) of the server according to the reason of the present abnormality.

12. The server as claimed in claim 9, wherein the operating system automatically copies the data in the memory and transmits the data to a baseboard management controller (BMC) of the server in response to the determination that the server is malfunctioning.
